(19) United States
(12) Patent Application Publication
(10) Pub. No.: US 2011/0284218 A1
(43) Pub. Date: Nov. 24, 2011

(54) Method for increasing the formation oil yield during crude oil production and apparatus thereof

(76) Inventors: Aleksei Aleksandrovich Chudnovsky, Moscow (RU); Georgy Zalkindovich London, Korolev (RU)

(21) Appl. No.: 12/932,106

(22) Filed: Feb. 17, 2011

(30) Foreign Application Priority Data
May 19, 2010 (RU) 2010120004

(51) Int. Cl. E21B 43/12; G06F 19/00; E21B 47/00

(52) U.S. Cl. 166/250.15; 702/6

(57) ABSTRACT

The invention relates to the field of producing the liquid subsoil assets, and could be used in the bottom-hole pumping of oil wells.

The method consists in creating a long wave impact onto the formation in the infra-low frequency range during cruse oil production. The method provides for a running validity check and analysis of change trend, as well as an operative control of the impact parameters in order for supporting the positive trends in the fluid production conditions and preventing the negative trends.

The apparatus for implementing the method consists of a switch, measure unit, control unit, and information monitoring unit, which is connected through a first and second modems and communication channel to the apparatus control unit, and a set of measurement devices of the productive complex. The switch, measure unit, control unit, and the first modem are arranged in close proximity to the well and ensure a local computerized control of the fluid production process and the impact. The information monitoring unit and the second modem could be arranged at removed data processing and analyzing centers, i.e., dispatching points, automated workstation of technologist, etc.

The apparatus ensures simultaneously the implementation of the cyclic mode of the production and wave impact onto the formation, as well as the measurement of the parameters of the fluid and productive complex.

### FIELD OF THE INVENTION

The invention relates to the field of producing the liquid subsoil assets, generally in the oil industry, and could be used, particularly, in the bottom-hole pumping of oil wells.

### BACKGROUND OF THE INVENTION

Known are methods of oscillation action onto a productive formation for the purpose of intensifying a fluid production. To those methods relates a method for intensifying an oil production and reviving idle wells by means of the electromagnetic resonance action onto a productive (RU Patent No. 2379489). The essence of this method consists in creating, by means of the control apparatus and generator/receiver, the modulated electromagnetic oscillations directed from the exploitation well and in opposite direction from one of nearest neighbor well towards the exploitation well. In so doing, the resonance electromagnetic oscillations are formed, which oscillations initiating oscillations of molecules and atoms of the carbon fluid with the peak resonance amplitude in the vertical, horizontal, and other plane. Peak resonances are directed towards the exploitation well as repeated runs during collisions with the collector frame.

The disadvantage of the method consists in the necessity to apply a specified complex and expensive ground and submersible apparatus in addition to the exploitation equipment. Moreover, the method realizes a local effect even though movable along the formation but not enlarged simultaneously to sufficiently extensive formation area and not ensuring the retention of effect through time. When employing the cyclic method of the oil production, the resonance oscillations interfere with the compression wave emerging due to the action of the exploitation equipment, which can distort the planned effect.

Known is as method for estimating analytically hydrodynamic parameters of the formation using the pressure recovery curve [V. I. Shchurov. Technology and technique of the oil production, Chapter VI, Section 3, pp. 197-203]). The disadvantage of the method consists in that for measuring the pressure recovery curve it is necessary to stop the extraction process for sufficiently long time, and this fact forces to apply this method for operating well only after very long periods of time.

Known is an influence of a deep penetration of oscillations into a formation with the simultaneous impact to an extensive area of the formation [Kolchitskaya T. N. et al. Influence of cyclic modes of well operation to condition alteration of gas and oil formations, pp. 81-84]). However, in this case the best frequency range is not defined.

Also known is a method for increasing the formation oil yield during crude oil production, in which method there are carried out steps of: creating periodically hydrodynamic pulses in the cyclic mode of the regular fluid extraction at a pumping rate exceeding a fluid influx rate; and determining the calculated parameters of the cycle in accordance with the complex of indices before beginning the exploitation (RU Patent No. 2190087).

The disadvantage of the method consists in that the cycle parameters, as well as the parameters of action on the formation, are set on the basis of calculation data in accordance with the conditions of the well and formation for the moment of the operation beginning. In the course of production, the energetics and filtration characteristics of formations change continuously, and it is impossible to predict their behavior in time. Accordingly, the data, on which basis the calculations are performed, are outdated rather quickly. Furthermore, because of the structural discontinuity of a formation, not the whole formation but only some parts thereof can response to the impact having particular parameters. Herewith, theoretically are possible, and practically occur situations when the impact has even the negative result. Totally, the method does not ensure the impact effectiveness validity check and the formation treatment parameter control.

As the closest analog for the apparatus, a control apparatus in accordance with the RU Patent No. 2352768 is taken, which apparatus including a switch 1, measure unit 2, control unit 3, modems 4 and 6 and communication channel 5. The first input of the switch is connected to the power line, and the second input is connected to the output of the control unit 3. The output of the switch is connected to the supply bus 8 of the pump electric drive and to the input of the measure unit 2. The output of the measure unit 2 is connected to the input of the control unit 3 which input/output port is connected to an external user through the modem 4, communication channel 5 and modem 6. The apparatus ensures the implementation of the extraction cyclic mode, i.e., controls the pumping set motor on-off and sets the cycle parameters in accordance to the operation program or instructions of the external user.

The disadvantage of this apparatus consists in the absence of managing the behavior of the parameters defining the trend of the formation characteristics.

### SUMMARY OF THE INVENTION

The technical problem consists in increasing the filtration characteristics of a formation by means of managing the wave action efficiency and controlling operatively the impact parameters in the cyclic mode of the crude oil production.

The technical result consists in increasing formation oil yield by means of correcting timely the change trend during the crude oil production.

This result is achieved by the following steps of:
measuring and storing, during the extraction, in order for checking operatively the extraction conditions, a group of running parameters of the fluid and production set;
plotting, with a period T1, a graphs of time dependence of the measured parameters;
estimating, in accordance with the obtained synchronous dependences, the change trend during the crude oil production and the physical significance of the changes;
measuring, in order for managing the estimation, a shortened pressure recovery curve ΔT with a period T2 and a full pressure recovery curve with a period T3;
forming, using those curves, running analytical estimations of the hydrodynamic parameters of the formation and time changes thereof;
comparing the running analytical estimations and running measurement estimations synchronized therewith;
revealing, storing, and accumulating patterns of the stable behavior of the group of measured parameters at the running time interval;
finding out a correspondence between the patterns of the parameter behavior and various variants of the formation response to the wave action;
estimating a correspondence between the real and required responses; and
deciding, in accordance with the result of the latter estimation, on storing, correcting or modifying essentially the value of the action parameters.

A pressure at the pump input, fluid influx rate, well yield, oil/water ratio in the produced fluid, fluid viscosity, fluid density, fluid accumulation time and pump-off time, energy consumption of the pumping set are included, while producing, into the list of the group of the measured parameters of the fluid and productive complex.

Prior to the step of measuring the pressure recovery curve, there are carried out steps of: pumping off the fluid from the well until the pumping plant is turned off in accordance with the boundary condition of the underload criterion; then, upon the pumping plant being turned off, measuring the actual pressure at the pump input serially at the time using an immersion sensor; registering a measurement sequence up to an end of the pressure growth or predetermined time interval ΔT; in accordance with the obtained curves and using the standard techniques, calculating running hydrodynamic parameters of the formation for the full and shortened variants of the pressure recovery curve; and storing, displaying, and documenting the registered curves in the form of tables and graphs with the time reference.

Duration of the period T1 is set on the basis of requirements of the fluid production, the duration of the period T2 is chosen taking into account the lag of processes of changing the fluid production conditions. The duration of the interval T3 is chosen so that it includes several intervals T2. The duration of the interval ΔT for the shortened pressure recovery curve is chosen so that this duration does not exceed the duration of several operation cycles of the pumping plant, but is significantly less than the duration of picking up the full curve. Herewith, the calculation error of the hydrodynamic parameters in accordance with the shortened curve is higher that in accordance with the full curve, but the shortened curve is quite applicable for conducting running estimations and justified by reducing the down time during production.

Values of the accumulation time and pump-off time intervals or boundary pressure values Pₘᵢₙ and Pₘₐₓ calculated on the basis thereof, as well as the fluid pump-off rate are used as action control parameters. Changing the boundary pressure values allows adjusting pressure wave amplitude and frequency. Changing the pump-off rate ensures the adjustment of the pump-off time to accumulation time ratio and thus enables to vary the pressure wave shape.

The initial boundary pressure values Pₘᵢₙ and Pₘₐₓ at the pump input are determined by means of superimposing a segment equal to the predetermined accumulation interval onto the time axis of the graph of the pressure recovery curve so as the average rate of the curve growth at the section is corresponds the expected yield.

The apparatus comprises, contrary to the known one, an information monitoring unit which input/output port is connected through the second modem and communication channel to the terminal of the set of measurement devices of the productive complex, and through the second modem, communication channel and first modem to the apparatus control unit.

### BRIEF DESCRIPTION OF THE DRAWINGS

FIG. 1 shows the block diagram of the control apparatus;

FIG. 2 shows the structure of the productive complex;

FIG. 3 shows the diagrammatic work of the control apparatus;

FIG. 4 shows the standard pressure recovery curve;

FIG. 5 shows the pressure wave shape;

FIG. 6 shows the diagrammatic work of the pumping set.

The following designations are used in all drawings:

1—switch, 2—measure unit, 3—control unit, 4—first modem, 5—communication channel, 6—second modem, 7—information monitoring unit, 8—supply bus of the pumping set, 9—well, 10—pumping set, 11—pressure sensor at the pump input, 12—oil reservoir, 13—set of devices for measuring fluid parameters, which are included into the production complex, T1—periodicity of graphs of measured parameters dependence, T2—periodicity of the shortened pressure recovery curve of the predetermined interval ΔT, T3—periodicity of the full pressure recovery curve.

The essence of the proposed method consists in the following:

In the cyclic mode of the pumping plant operation, a wave of the pressure to the formation according to the stricture “depression—recovery” is formed. In the cycle pump-off phase, the depression onto the formation is created; in the cycle accumulation phase, the formation pressure is recovered under the action of water rush from injection wells. Thus, the wave action onto the formation is carried out using the same pumping equipment, which is used for producing the fluid. Duration of the action in this case is equal to the duration of the well operation process (a year and more), and the action wave frequency corresponds to a frequency of the fluid production, i.e., is in the infra-low frequency range. Studies have shown that the most deep and effective penetration of the oscillations into the formation and, simultaneously, an impact to extensive formation area is ensured just in this frequency range.

As a result, a multiple, long cyclic impact onto the formation in the infra-low frequency range results in reducing the rock structure strength, creating micro-fractures, expanding the rock interstitial space, as well as cleaning pore channels from squeezing particles, and, as a result, in enhancing the filtration characteristics of formation and increasing the oil recovery. By means of a long impact, the formation area covered by the impact is expanded, and, accordingly, a well drainage area is increased.

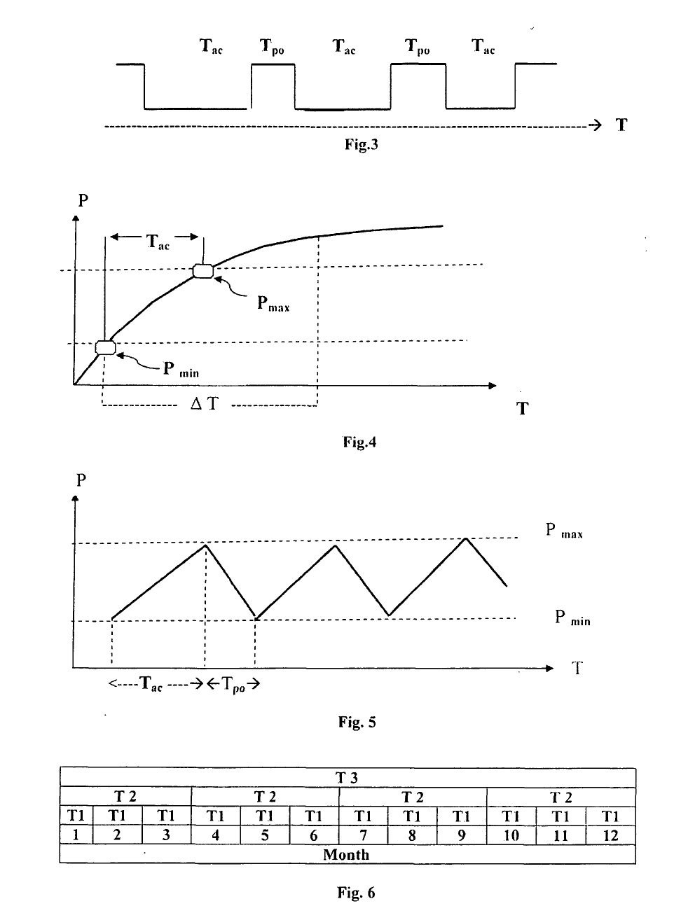

Prior to the extraction beginning, in accordance with the technique of the closest analog method, values of the cycle parameters, i.e., the pump-off time Tₚₒ and the fluid accumulation time T_{ac} in the annular space (FIG. 3) are assigned; a pumping plant having the performance exceeding the expected production is selected and installed: and the fluid is pumped-off from the well up to the minimal possible level, i.e., up to the engine stopping according to the underload signal.

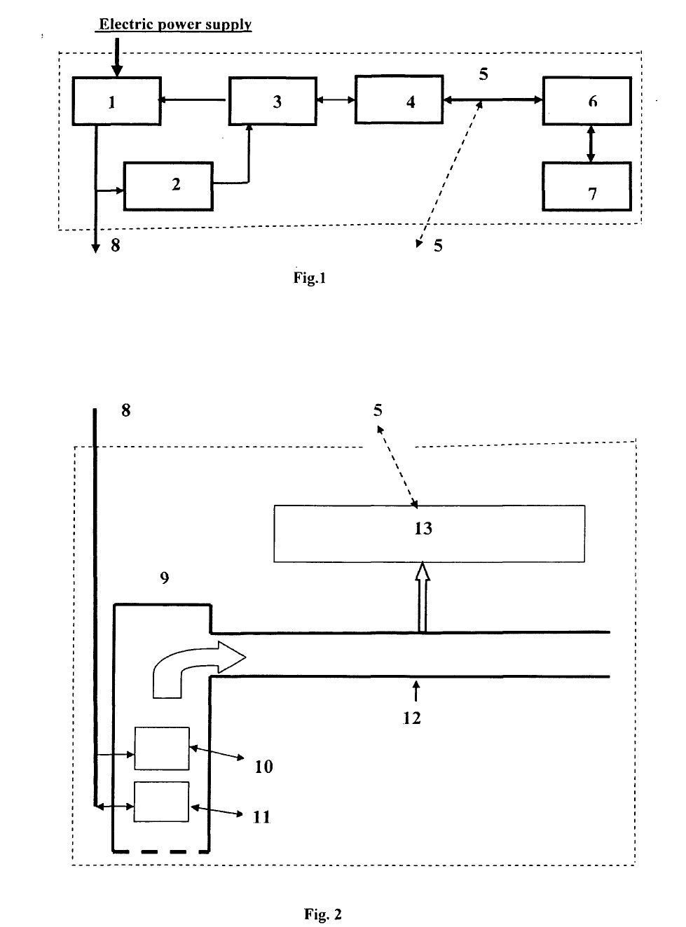

Further, while the engine is powered off, the full pressure recovery curve is measured using the control apparatus (FIG. 1) and the pressure immersion sensor 11 (FIG. 2), and plotted in the graph (FIG. 4). In order for determining the boundary pressure values, the time segment T_{ac} is arranged at the time axis T (FIG. 4) so that the average slope of the curve at the segment T_{ac} corresponds to the expected production. Point above the curve corresponding to the beginning and end of the segment T_{ac} (Pₘᵢₙ and Pₘₐₓ) are determined further as the boundary pressure values at the pump input; they are input into the memory of the control unit 3 and used as the primary parameters of the pumping plant.

During the subsequent operation, the pumping plant is powered on, when the pressure in the well reaches the upper boundary, and powered of, when the pressure reaches the lower boundary; in each cycle, the plant down time and operation time are measured and logged. As a result, the cyclogram of the pumping set looks like the graph in FIG. 3. The pressure graph (FIG. 5) has a form of a wave with the peak-to-peak value (Pₘₐₓ-Pₘᵢₙ) and cycle period equal to T_{ac}+Tₚₒ. In the case of real cycle parameters, for example, the period having a value of the order of 3 hours (10800 seconds), the wave frequency is in the range of 10⁻⁴ Hz. The deepest penetration of the pressure wave into the formation and, accordingly, increase of the impact area thereof is ensured just in this frequency range (infrasound frequencies lower than 0.5 Hz).

During the well operation, measurements of a group of parameters are performed with a technologically reasonable period T1 (for example, 2 weeks to 1 month). Contrary to the method of the closest analog, only those parameters are included into the group, which are available for measurements during the fluid production. The time-clocked and dated data group is stored in the records of the control apparatus.

Involving the group of parameters into the analysis is caused by that every of them characterizes only particular changes in the production conditions, which changes are not always single-valued, rather than the overall directivity of the changes. For example, increasing the fluid production can mean both increase of the oil production and increase of water cut. Therefore, the group of parameters is involved into the analysis, which group includes: pressure at the pump input, well production, oil/water ratio in the produced fluid, fluid viscosity, fluid density, accumulation time T_{ac} and pump-off time Tₚₒ, energy consumption of the pumping set, etc. Graphs of each parameter as a function of time are plotted at a single carrier for coprocessing these parameters. Using the obtained dependencies, the trend of production conditions and physical significance thereof are estimated.

For example, if the accumulation time T_{ac} increases in the fixed boundary pressure values (Pₘᵢₙ and Pₘₐₓ), this indicates the decrease of the average fluid influx rate. If this time decreases gradually, then this is an indication of increasing the influx rate. The average rate changes should correspond to the production change and be confirmed thereby.

Change of the fluid viscosity is indicative of involving into the flux other types of oil absent earlier in the flux, i.e., indicative of widening the area of formation stimulation.

Changes of the fluid density are indicative of changing fluid content. The same data are confirmed by changes of the pump-off time and energy consumption of the pumping set.

Change of the oil/water ratio in the fluid characterizes a change of the formation productivity.

According to the group of parameters, which persistent changes have synchronous, implicitly single direction, versions of the vector of changes of the formation structure are evaluated, their changes are determined according to the change meaning, and further estimated as positive and negative in terms of the assigned technical problem. The unity of the directivity of changes of various parameters in the group are recognized as an indication of the estimation certainty.

For example, if the production enhancement is accompanied with increase of the fluid density and increase of the water part in the fluid content, then, this means the increase of watering, and such a trend is recognized as negative. And conversely, if the oil part in the fluid increases, then, such a trend is recognized as positive while maintaining or increasing the production, and a decision is made on maintaining the cycle parameters.

In order for checking the estimation in accordance with the measured parameters, this estimation is compared with analytical, calculated estimations which are obtained using standard techniques. In order for obtaining the calculated estimations, the shortened pressure recovery curve ΔT is measured with the predetermined period T2 (for example, 3 months). The duration of the shortened curve ΔT (FIG. 4) is assigned so that it includes several operation cycles of the pumping equipment, for example 24 hours. It is inexpedient and inadmissible, on the technological grounds, to measure the full curve often, since this procedure is time consuming (several days), and its performing results in ceasing the fluid production process. The results of the calculated estimations by the pressure recovery curves and changes thereof are compared with the time-changing estimations by the measured parameters.

From the comparison results, stable behavior samples of the group of the measured parameters are revealed, and the correspondence of the behavior samples with various variants of formation response to the wave impact having specific parameters is determined. Various kinds of the response includes, for example, such as increase of production, increase of watering, absence of changes, i.e., stabilization, etc.

Upon revealing the specific directivity, the divergence thereof with the required directivity is evaluated, and the cycle parameters are maintained or changed, such as durations of the pumping-off phase and accumulation phase, or pumping-off speed for maintaining or changing the process evolution vector, from the comparison and interpretation results.

During a long operation, the full pressure recovery curve is measured with the period T3 (1 year), hydrodynamic characteristics of the formation are evaluated in accordance therewith, these characteristics are compared with the characteristics at the previous period T3, the formation impact efficiency is determined according to the revealed changes and results of the intermediary estimations, and the estimations obtained by the shortened curves are monitored.

The advantage of the method consists in the possibility for creating a long testable and controllable wave impact onto the formation in the infra-low frequency range using a standard pumping equipment without attraction of additional technical means.

The efficiency of the method consists in expanding the external reservoir boundary and increasing the formation deliverability. By means of this, the oil production from the well increases and, accordingly, the need for developing new wells in order for covering totally the formation with drainage reduces. Practical results of using the method consist in increasing the oil production volume from one well by 10 to 25%.

Expanding the external reservoir boundary is ensured by means of the long wave impact onto the formation in the infra-low frequency range.

The formation deliverability increases by means of controlling operatively the impact parameters in order for supporting the positive trends in the fluid production conditions, or for preventing the negative trends.

### Implement of the Method

The method is implemented using the apparatus, including: a switch 1, measure unit 2, control unit 3, first and second modems 4 and 6, communication channel 5, and information monitoring unit 7. The first input of the switch 1 is connected to the power line, the second input of the switch 1 is connected to the output of the control unit 3. The output of the switch 1 is connected to the supply bus 8 of the pumping plant and to the input of the measure unit 2. The output of the measure unit 2 is connected to the input of the control unit 3. The input/output port of the control unit 3 is connected to the first modem 4, the input/output port of the information monitoring unit 7 is connected, through the second modem 6 and communication channel 5, to the first modem 4 and terminal of the measuring and analyzing device set 13 of the productive complex.

The switch 1 carries out a commutation of power network voltage and ensures the power on and off for the pumping set motor by the command from the control unit 3.

The measure unit 2 carries out the validity check of the pumping set state (on-off) by means of measuring and analog-to-digital converting a value of a current consumed by the motor, as well as receiving and converting signals of the immersion pressure sensor 11, which signals being transmitted via the supply bus 8 of the pumping plant. Output signals of the measure unit 2 are transmitted to the input of the control unit 3.

The control unit 3 realizes the cyclic operation mode of the pumping set, herewith it controls the operation of the switch 1, receiving data from the measure unit 2, measures durations of the accumulation interval T_{ac} and pump-off interval Tₚₒ (FIG. 3), and performs an information exchange with the information monitoring unit 7 via the communication channel 5 through the modems 4 and 6. During the information exchange, the control unit 3 transmits the measured data (currents, pressure, durations) to the unit 7, and receives therefrom and uses for the control the parameters of the operation cycle of the pumping plant (Pₘᵢₙ and Pₘₐₓ).

The first and second modems 4 and 6 ensure the physic and logic matching of subscriber devices (units 3 and 7) with the communication channel 5.

The information monitoring unit 7 ensures an information collection from the control unit 3 and measuring means 13 of the productive complex, as well as carries out steps of archiving the data, processing, operative displaying and recording thereof.

The units 1, 2, 3 and 4 are arranged in close proximity to the well and ensure a local computerized control of the fluid production process.

The units 6 and 7 can be removed regionally from the wells and located in the data processing and analyzing centers.

The apparatus operates as follows.

In order for implementing the functions provided by the method, the apparatus ensures the operation in the following modes:
Operational (production) mode, which mode realizes steps of collecting the data from the immersion pumping plant, and controlling the plant power on-off. The mode is performed permanently.
Mode for collecting the data from the measuring device set of the production complex, which mode is performed periodically with the period T′ (from 2 weeks to 1 month) without stopping the oil production.
Adjustment and efficiency check mode, which mode carries out the measurement of the full pressure recovery curve. The mode is performed prior to the extraction beginning and, further, periodically with the period T3 (about 1 year). The mode is performed upon stopping the extraction process for 3 to 4 days, but without pulling the downhole pumping equipment.
Validity check mode, i.e., mode for measuring the time-shortened pressure recovery curve (ΔT) with the performance period T2 (about 3 to 4 months). The mode is performed with the short (not more than day and night) stopping the production.

### Example of the operation cyclogram of the control apparatus

(FIG. 3)

In the operational mode, the fluid production is carried out in the cyclic mode. Herewith, the immersion pressure sensor 11 (FIG. 2) transmits data via the power supply bus 8 to the measure unit 2 that converts thereof to the standard digit form and transmits to the control unit 3. The periodicity of the transmission is 10 to 20 seconds. The unit 3 compares the running data with the predetermined Pₘᵢₙ and Pₘₐₓ (FIG. 4) and, correspondingly, powers on and off the pumping plant, thus implementing the cyclic operation mode thereof. The unit 3 carries out the validity check of executing the cyclic mode in accordance with the results of measurements of the current in the power bus 8, which measurements are performed by the unit 2. In each cycle, the unit 3 measures the durations of the accumulation interval T_{ac} and pump-off interval Tₚₒ of the pumping plant (FIG. 3), and transmits these data to the information monitoring unit 7 via the communication channel 5 through the modems 4 and 6. The unit 7 accumulates the received data and the time codes accompanying thereof in the first section of the data archive. The rate of the data reception is equal to the operation duration of the equipment (for example, 3 hours). The unit 7 calculates also the average values of those parameters for the period T1 (from 2 weeks to 1 month), which is necessary for revealing stable changes and for equalizing the rates of accumulating relative fast and slow types of data.

The mode for collecting the data from the measuring device set 13 (FIG. 2) is activated in the end of the interval T1 (FIG. 6), for example, at the end of a month or two-week period. In this mode, the unit 7 receives data from the terminal 13 via the channel 5, sets those data to the unified form of presentation, and accumulates the formed data and corresponding time codes in the second section of the archive. The data T_{ac} and Tₚₒ averaged at the intervals T1 and the current values of the boundary amounts Pₘᵢₙ, and Pₘₐₓ are stored in the same archive section. As a result, the second section of the archive accumulates records of the groups of the parameters having the single reception rate and characterizing time steps of status of the production conditions. Usage of two archive section is explained by significant difference of the data reception rates to the different sections. The data of the first section allow to analyze relatively fast changes, and the data of the second section allow to analyze stable trends.

The unit 7 ensures steps of analyzing the production process and revealing the directionality of the time changes by means of the visual displaying and documenting the archived data in the tabular and graphic forms.

In the adjustment and efficiency check mode, the apparatus ensures the steps of measuring and plotting the full pressure recovery curve (FIG. 4). In this mode, the maximum possible fluid pump-off (until the pumping plant is turned off due to the underload) is carried out, then, during the fluid influx, the running pressure measurement is performed using the immersion sensor 11 (FIG. 2). The sensor 11 transmits the pressure data via the power supply bus 8 (FIG. 2) to the measure unit 2 and, subsequently, upon conversion, to the control unit 3 (FIG. 1). A period for refreshing the data is 10 to 20 seconds. The control unit 3 fixes the data and time of receiving thereof, accumulates the data during the predetermined time interval, and forms a data packet. Further, the unit 3 transmits the composed data packet to the information monitoring unit 7. The rate for accumulating and transmitting the data is set so as to not overload the communication channel, and, at the same time, enable for managing the creation of the pressure recovery curve in the real time (every 10-20 minutes). The unit 7 stores the received packets and displays the images at the monitor screen and in the form of a document (table, graph), if necessary. The operator sets the values Pₘᵢₙ, and Pₘₐₓ at the pressure recovery curve recorded in the form of the graph in accordance with the predetermined interval T_{ac} and expected production amount, and transmits the values of those parameters to the unit 3. The unit 3 uses these values for controlling regularly the production cycle. The adjustment mode is performed prior to the extraction beginning and, further, periodically with the period T3, for example, 1 year, or if necessary (for example, after repairing). The obtained curves are accumulated on the third section of the archive of the unit 7 and used further for calculations and comparison during the analysis.

In the validity check mode, the steps of measuring and plotting the time-shortened pressure recovery curve (ΔT, FIG. 4) are performed using the apparatus. The period of performing is T2 (about 3 to 4 months). The validity check mode is performed with the short (not more than day and night) stopping the production. The mode is fully similar to the adjustment mode by its execution, but is performed at a shorter time. The measured curves are accumulated in the third section of the archive of the unit 7. Hereafter, they are use for calculations and comparison during the analysis. The duration of the interval ΔT for the shortened pressure recovery curve is chosen so that this duration does not exceed the duration of several operation cycles of the pumping plant, but is significantly less than the duration of measurement of the full curve. Herewith, the error for calculating the hydrodynamic parameters according to the shortened curve is higher than according to the full curve, however, it is well admissible for performing the running estimations and justified by reducing the down time during production.

As a whole, the apparatus operation dynamic has a character of embedded cycles. The general, longest cycle T3 includes the shorter cycles T2 and T1 (FIG. 6), and the functions stipulated by the method, i.e., adjustment, normal operation, primary information collection, trend analysis and adjustment correction are distributed by those cycles.

The control unit 3 is implemented on the basis of standard microcontrollers (for example, PIC-processors) supplemented by switching elements for controlling the switch 1.

The modems 4 and 6 are implemented depending on the employed communication channel. They can be interface modules RS-485 with the wire link, or cellular communication and GPRS-modems in the case when the unit 7 is removed from the wells.

The information monitoring unit 7 is a standard personal computer upgraded with a printer and plotter (for documenting time-extended graphs).

Block 7 function in various modes of the device realize, in general, with standard computer software.

Operation system, for example,—Windows 7.

Communication with controlled blocks, as well, as functions of data collection support with drivers of selected protocols and communication channels

Data storage provided by one of the standard databases, such as, for example, database My SQL.

Memory capacity of Hard Disk Drive (HDD), should be sufficient to store archived data for several years (enough volume of 500 GB)

Data averaging, graphical and tabular display, as well, as documentation, perform, for example, by using Microsoft Excel.

Because the rate of receipt of data—is fairly low, high demands on operation speed to a computer is not claimed.

Programs, according to their complexity, are available for the implementation of the programmer of average skill.

Computer characteristics should provide a comfortable work when using the listed above standard programs.

1. A method for increasing a formation oil yield during crude oil production, the method comprising steps of:
creating periodically hydrodynamic pulses in a cyclic mode of a regular fluid extraction at a pumping rate exceeding a fluid influx rate;
determining calculated parameters of the cycle mode in accordance with a complex of indices before beginning the exploitation;
measuring and storing, during the fluid extraction in order for managing operatively extraction conditions, a group of running parameters of the fluid and production set;
plotting, with a period T1, a graphs of time dependence of the measured parameters;
estimating, in accordance with obtained synchronous dependences, a change trend during the crude oil production and physical significance of changes;
measuring a shortened pressure recovery curve ΔT with a period T2 and a full pressure recovery curve with a period T3;
forming, using those curves, running analytical estimations of hydrodynamic parameters of the formation and time changes thereof;
comparing running analytical estimations and running measurement estimations synchronized therewith;
revealing, storing, and accumulating patterns of a stable behavior of the group of measured parameters at the running time interval according to results of the step of comparing;
finding out a correspondence between the patterns of the parameter behavior and various variants of a formation response to the wave action;
estimating a correspondence between real and required responses; and
deciding on storing, correcting or modifying essentially the value of the action parameters in accordance with a result of the latter estimation.

2. The method according to claim 1, wherein the list of the group of the measured parameters of the fluid and production complex during the crude oil production includes a pressure at a pump input, fluid influx rate, well yield, oil/water ratio in the produced fluid, fluid viscosity, fluid density, fluid accumulation time and pump-off time, and energy consumption of the pumping set.

3. The method according to claim 1, wherein, prior to the step of measuring the pressure recovery curve, the method includes steps of:
pumping off the fluid from the well until a pumping plant is turned off in accordance with a boundary condition of a underload criterion; upon a pumping plant being turned off, measuring a actual pressure at a pump input serially at the time using an immersion sensor; registering a measurement sequence up to an end of the pressure growth or predetermined time interval ΔT; in accordance with obtained curves and using standard techniques, calculating running hydrodynamic parameters of the formation for full and shortened variants of the pressure recovery curve; and storing, displaying, and documenting registered curves in the form of tables and graphs with the time reference.

4. The method according to claim 1, wherein a duration of the period T1 is set on the basis of requirements of the fluid production, the duration of the period T2 is chosen taking into account a lag of processes of changing the fluid production conditions, the duration of the interval T3 is chosen so that it includes several intervals T2, the duration of the interval ΔT for the shortened pressure recovery curve is chosen so that this duration does not exceed the duration of several operation cycles of the pumping plant, but is significantly less than the duration of picking up the full curve; herewith, the calculation error of the hydrodynamic parameters in accordance with the shortened curve is higher that in accordance with the full curve, but the shortened curve is quite applicable for conducting running estimations and justified by reducing the down time during production.

5. The method according to claim 1, wherein values of the accumulation time and pump-off time intervals or boundary pressure values Pₘᵢₙ and Pₘₐₓ calculated on the basis thereof, as well as the fluid pump-off rate are used as action control parameters; changing the boundary pressure values allows to adjust pressure wave amplitude and frequency; changing the pump-off rate ensures the adjustment of the pump-off time to accumulation time ratio and thus enables to vary the pressure wave shape.

6. The method according to claim 1, wherein the initial boundary pressure values Pₘᵢₙ and Pₘₐₓ at a pump input are determined by means of super-imposing a segment equal to the predetermined accumulation interval onto a time axis of the graph of the pressure recovery curve so as the average rate of the curve growth at the section corresponds the expected yield.

7. A control apparatus for implementing a method for increasing a formation oil yield during crude oil production,
said apparatus comprising a switch, a measure unit, a control unit, first and second modems and a communication channel, wherein a first input of the switch is connected to a power line, a second input of the switch is connected to an output of the control unit, an output of the switch is connected to a supply bus of a pump electric drive and to an input of the measure unit, which output is connected to an input of the control unit which input/output port is connected through the first modem and communication channel to the second modem, wherein the apparatus further comprising an information monitoring unit which input/output port is connected through the second modem and communication channel to a terminal of a set of measurement devices of a productive complex, and through the second modem, communication channel and first modem to the control unit.
